(19) United States
(12) Patent Application Publication
(10) Pub. No.: US 2014/0252104 A1
(43) Pub. Date: Sep. 11, 2014

(54) PORTABLE SELF-PRESSURIZING SPRAY SYSTEM

(71) Applicant: OutSol Inc., Oceanside, CA (US)

(72) Inventor: Christopher Jackson Crawford, Oceanside, CA (US)

(73) Assignee: OutSol Inc., Oceanside, CA (US)

(21) Appl. No.: 14/204,322

(22) Filed: Mar. 11, 2014

Related U.S. Application Data
(60) Provisional application No. 61/776,635, filed on Mar. 11, 2013.

(51) Int. Cl. B05B 9/04; A47K 3/28

(52) U.S. Cl. CPC B05B 9/04; A47K 3/28
USPC 239/1; 239/373; 4/616

(57) ABSTRACT

A portable, self-pressurizing sprayer or shower system includes a pressure container within a tank. Pressurized fluid, such as water from a residential water tap, is fluidly connected to the pressure container to fill and pressurize the system with the fluid. The sprayer system is then disconnected from the pressurized fluid source and transported to a remote location. A tube is then fluidly connected to the pressure container and the pressurized fluid is released through the tube to provide a portable sprayer system.

### CROSS REFERENCE TO RELATED APPLICATIONS

This application claims the benefit of U.S. Provisional Patent Application No. 61/776,635 filed on Mar. 11, 2013, the entirety of which is hereby incorporated by reference.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of portable spray systems, and more specifically toward a portable, self-pressurizing sprayer or shower system. The sprayer system includes a pressure container within a tank. Pressurized fluid, such as water from a residential water tap, is fluidly connected to the pressure container to fill and pressurize the system with the fluid. The sprayer system is then disconnected from the pressurized fluid source and transported to a remote location. A tube is then fluidly connected to the pressure container and the pressurized fluid is released through the tube to provide a portable sprayer system.

Many individuals enjoy travelling to remote locations that have no running water. At the same time, there is still a demand for washing various items, including the individual himself or herself. Washing in a stream or river can be dangerous and unhealthy should the stream or river be contaminated. Transporting water in containers overcomes the problem of contaminated water, but it can be difficult to dispense water from the containers. Pressurizing the water in a remote location, as taught by the prior art, has involved operating a pump (usually manually) or raising the container of water to a sufficient height to use gravity as a way of providing pressure.

Thus there has existed a long-felt need for a system and method to easily provide pressurized water to a remote location.

### SUMMARY OF THE INVENTION

The current invention provides just such a solution by having a portable, self-pressurizing sprayer or shower system. The sprayer system includes a pressure container within a tank. Pressurized fluid, such as water from a residential water tap, is fluidly connected to the pressure container to fill and pressurize the system with the fluid. The sprayer system is then disconnected from the pressurized fluid source and transported to a remote location. A tube is then fluidly connected to the pressure container and the pressurized fluid is released through the tube to provide a portable sprayer system.

It is an object of the invention to provide a system for transporting and dispensing a volume of fluid under pressure.

It is another object of the invention to provide a method for spraying a fluid transported to a remote location.

It is a further object of this invention to provide a system for transporting a pressurized fluid.

It is yet another object of this invention to provide a portable self-pressurizing shower system.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims.

### BRIEF DESCRIPTION OF THE FIGURES

The accompanying drawings, which are incorporated in and form a part of this specification, illustrate embodiments of the invention and together with the description, serve to explain the principles of this invention.

FIG. 1 is a cross-section side view of a portable, self-pressurizing spray system according to selected embodiments of the current disclosure.

FIG. 2 is a top perspective view of a portable, self-pressurizing spray system according to selected embodiments of the current disclosure.

FIG. 3 is top view of a portable, self-pressurizing spray system according to selected embodiments of the current disclosure.

FIG. 4 is a cross sectional view, taken along plane E-E of FIG. 3, of a portable, self-pressurizing spray system according to selected embodiments of the current disclosure.

FIG. 5 is cross sectional view, taken along plane G-G of FIG. 3, of a portable, self-pressurizing spray system according to selected embodiments of the current disclosure.

FIG. 6 is a side view of a portable, self-pressurizing spray system according to selected embodiments of the current disclosure.

FIG. 7 a cross sectional side view, taken along plane D-D of FIG. 6, of a portable, self-pressurizing spray system according to selected embodiments of the current disclosure.

### DETAILED DESCRIPTION OF THE INVENTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

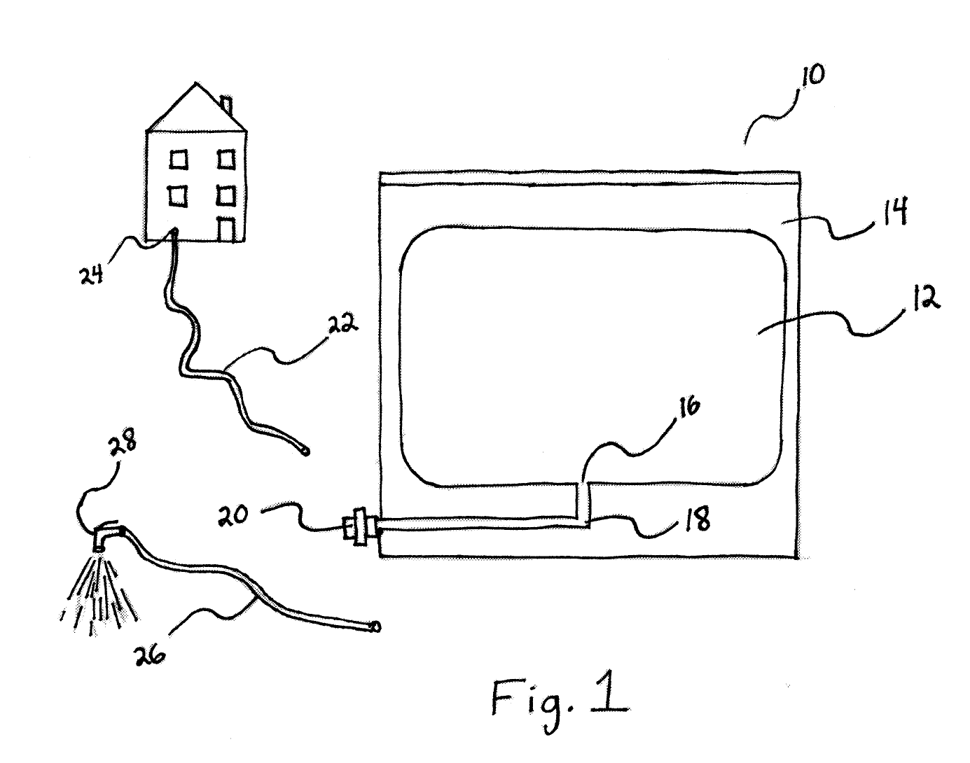

FIG. 1 illustrates a portable, self-pressurizing sprayer system 10, or shower, according to a particular embodiment of the current disclosure. In this embodiment, the shower 10 comprises a tank 14 encasing a pressure container 12. A first end of a conduit 18 is attached to an opening in the pressure container 12. A second end of the conduit 18 is disposed through an opening of tank 14 and is attached to a pressure container inlet/outlet coupler 20. Pressure container comprises an airtight seal, whereby the pressure container is airtight, except for the fluid connection to the conduit 18. Thus, when conduit 18 is sealed, the conduit and pressure container form a completely airtight container.

In various embodiments, tank 14 and pressure container 12 can be different shapes and sizes. For example, tank 14 and pressure container 12 can be substantially round, oval, square, rectangular or other shape so long as pressure container 12 is substantially located within and supported by tank 14. In the embodiment shown in FIG. 1, tank 14 is substantially rectangular in shape with a height of approximately sixteen inches and a diameter of approximately nine inches. Likewise, pressure container 12 is substantially cylindrical in shape with a height of approximately fourteen inches and a diameter of approximately six inches.

Typically, conduit 18 is substantially tube-shaped to allow fluid to flow in and out of pressure container 12. In an embodiment, conduit 18 is approximately twelve inches in length and approximately one-half inches in diameter.

In various embodiments, tank 14, pressure container 12 and conduit 18 comprise any substantially rigid material such as plastic or metal. Generally, the rigid material(s) comprising pressure container 12 and conduit 18 must be able to withstand a pressure of at least approximately sixty to one-hundred pounds per square inch (60-100 psi). In various embodiments, tank 14, pressure container 12 and conduit 18 comprise plastic materials such as polyvinyl chloride (PVC) or polyethylene plastic. These types of materials are durable, washable and relatively easy to manufacture. The above dimensions and materials are examples, and it is recognized that these dimensions and materials can be modified depending upon such factors as amount of fluid that is desired for spraying. In a particular embodiment, the tank, pressure container, and conduit are made from rigid material(s).

The pressure container inlet/outlet coupler 20 allows fluid both to enter conduit 18 to fill pressure container and to exit conduit 18 for dispensing. Located on the exterior of the tank 14, pressure container inlet/outlet coupler 20 is capable of connecting to a first end of a first hose 22. A second end of first hose 22 can be connected to any source of fluids that are used to fill the spray system 10. In an embodiment, pressure container inlet/outlet coupler 20 comprises a standard quick release fitting with a size of one-half inches, and a first hose 22 comprises a standard garden hose. In this embodiment, the second end of first hose 22 is connected to a standard residential water tap to provide water to fill sprayer system 10. Pressure inlet/outlet coupler 20 is also capable of connecting to a first end of a second hose 26. In alternative embodiments, second hose 26 can be the same as first hose 22 in order to aid transportability and ease of use. A second end of second hose 26 comprises or is connected to a spryer 28. In a particular embodiment, sprayer 28 comprises a standard trigger-handle spray nozzle.

For operation of the portable, self-pressurizing sprayer system 10, water is turned on at the residential water tap source and flows through first hose 22 to pressure inlet/outlet coupler 20. The water then flows through conduit 18 and begins to fill pressure container 12. Because pressure container 12 is sealed air-tight, ambient air located within pressure container 12 begins to compress as the water flows into pressure container 12. Once sprayer system 10 is filled with a desired amount of water, the user turns off the water tap source and disconnects the first end of first hose 22 from pressure inlet/outlet coupler 20. At this point, sprayer system 10 is transportable to any location for use, and the water held within pressure container 12 is now stored under pressure of approximately 60-100 psi, or that which was provided by the residential water tap source.

When the user decides the appropriate time and location to dispense the water, second hose 26 is attached to pressure inlet/outlet coupler 20. By initiation of spryer 28, the stored-up pressure inside of pressure container 12 forces water to flow from pressure container 12 through conduit 18, pressure inlet/outlet coupler 20, hose 26 and to discharge through sprayer 28.

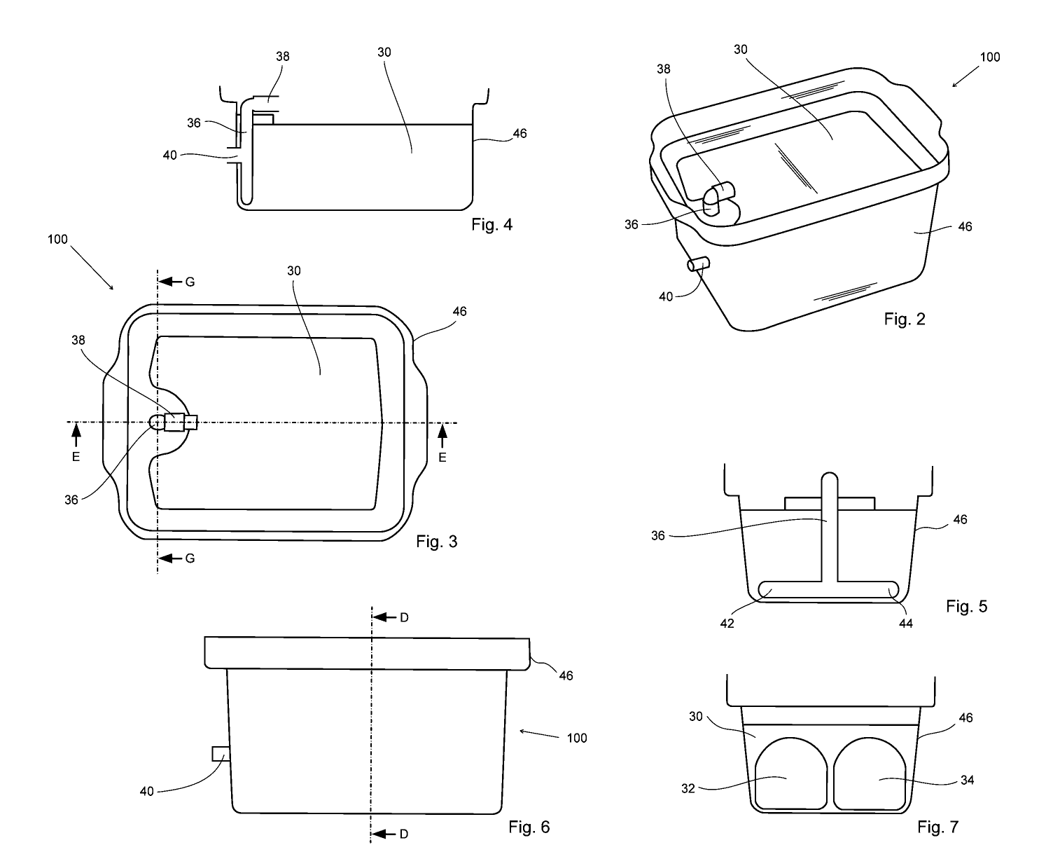

FIGS. 2 through 7 illustrate a portable, self-pressurizing spray system 100 in an alternative embodiment. In this embodiment, spray system 100 comprises a tank 46 encasing a pressure container system 30. Pressure container system 30 comprises a first pressure sub-container 32 and a second pressure sub-container 34. First pressure sub-container 32 and second pressure sub-container 34 are attached and fluidly connected to a conduit 36. Conduit 36 comprises a first pressure sub-container inlet/outlet 42, a second pressure sub-container inlet/outlet 44, a filling inlet 40 and a dispensing outlet 38. First pressure sub-container inlet/outlet 42 is attached to first pressure sub-container 32, and second pressure sub-container inlet/outlet 44 is attached to second pressure sub-container 34. Filling inlet 40 is disposed through an opening of tank 46. Pressure container system 30 comprises an air-tight seal.

In the embodiment shown in FIGS. 2-7, tank 46 and pressure container system 30 are substantially rectangular in shape and pressure container system 30 is substantially located within and supported by tank 46. In this embodiment, tank 46 has a length of approximately seventeen inches, a width of approximately fourteen inches, and a height of approximately twenty inches. First pressure sub-container 32 and second pressure sub-container 34 are substantially rectangular in shape, with lengths of approximately twelve inches, widths of approximately six inches, and heights of approximately eight inches.

Typically, conduit 36 is substantially tube-shaped to allow fluid to flow in and out of pressure container system 30. In an embodiment, conduit 36 is approximately four inches in length and one-half inches in diameter.

In various embodiments, tank 46, pressure container system 30 and conduit 36 comprise any substantially rigid material such as plastic or metal. Generally, the rigid material(s) comprising pressure container system 30 and conduit 36 must be able to withstand a pressure of at least approximately 60-100 psi. In various embodiments, tank 46 pressure container, system 30 and conduit 36 comprise plastic materials such as polyvinyl chloride (PVC) or polyethylene plastic. These types of materials are durable, washable and relatively easy to manufacture. The above dimensions and materials are examples, and it is recognized that these dimensions and materials can be modified depending upon such factors as amount of fluid that is desired for spraying.

The filling inlet 40 allows fluid to enter and flow through conduit 36 to fill pressure container system 30. Similarly, dispensing outlet 38 allows fluid to exit pressure container system 30 via conduit 36. On the exterior of tank 46, filling inlet 40 is capable of connecting to a first end of a first hose (such as hose 22 shown in FIG. 1). A second end of first hose can be connected to any source of fluids that are used to fill sprayer system 100. In one embodiment, filing inlet 40 comprises a standard quick release fitting with a size of one-half inches. In one embodiment, first hose is a standard garden hose. In this embodiment, the second end of first hose is connected to a standard residential water tap to provide water to fill sprayer system 100. In another embodiment, dispensing outlet 38 is also capable of connecting to a first end of a second hose (such as second hose 26 shown in FIG. 1). In various embodiments, the second hose can be the same hose as the first hose or a separate hose. A second end of second hose comprises or is connected to a sprayer. In an embodiment, sprayer comprises a standard trigger-handle spray nozzle.

For operation of the portable, self-pressurizing sprayer system 100, water is turned on at the residential water tap source and flows through first hose to filling inlet 40 and conduit 36. The water then flows through conduit 36 and begins to fill first pressure sub-container 32 and second pressure sub-container 34 in pressure container system 30. Because first pressure sub-container 32 and second pressure sub-container 34 are sealed air-tight, ambient air located within pressure container system 30 begins to compress as the water flows into pressure container system 30. Once sprayer system 100 is filled with a desired amount of water, the user turns off the water tap source and disconnects the first end of first hose from filling inlet 40. At this point, sprayer system 100 is transportable to any location for use, and the water held within pressure container 12 is now stored under pressure of approximately 60-100 psi, or that which was provided by the source of fluid.

When the user decides the appropriate time and location to dispense the water, a second hose (or the same hose as originally used) is attached to dispensing outlet 38. By initiation of a sprayer integrated with or attached to the second hose, the stored-up pressure inside of pressure container system 30 forces water to flow from first pressure sub-container 32 and second pressure sub-container 34 through conduit 36, dispensing outlet 38, second hose and to discharge through the sprayer.

Another embodiment provides for a portable shower system with a flexible, expandable bladder as a pressure container within the tank. There is an airtight chamber between the tank (external structure) and the pressure container, where the airtight chamber is filled with a gas (such as air) at an ambient pressure. The pressure container includes a port providing fluid access to the pressure container. When a fluid source (under pressure, such as a residential water tap) is connected to the pressure container, fluid fills the pressure container causing it to expand. As the pressure container fills with fluid and expands, the pressure in the airtight chamber between the tank and pressure container increases. Eventually, the pressure in the airtight chamber will equal that inside the pressure container. The fluid source is then disconnected from the pressure container, and the pressure container is sealed. The portable shower system is then transported to another location. A hose with a nozzle, or other dispensing tube, is fluidly connected to the pressure container. The pressure of the gas in the airtight chamber acts upon the pressure container. As the nozzle is opened, the pressurized fluid in the pressure container flows through the hose and out the nozzle. In this manner, a portable shower system may be utilized to spray a fluid in a remote location.

Further embodiments include multiple pressure containers of the same or differing shape. Those skilled in the art will appreciate that larger pressure containers or a greater number of pressure containers is required to hold and dispense larger volumes of fluid. At the same time, smaller pressure containers and fewer pressure containers will allow for an overall smaller spray system size that is lighter and easier to transport, and may be well suited for situations where a limited quantity of pressurized fluid is sufficient.

In yet another embodiment, the tank of the spray system has wheels attached thereto or incorporated therein. Wheels, for example, affixed to one end of the tank (one on each side) enable a user to lift one end of the spray system, and have the other end supported by the wheels. Another embodiment provides for a separate wheel system that attaches to and/or connects with the tank of the spray system. The tank rests on top of and may be secured to a platform, where wheels are secured to one end or both ends of the platform.

In a particular embodiment, the spray system further comprises a heater. Using the spray system as a shower, while sufficient with cold water, is preferable if warm water is dispensed. In one embodiment, heater coils are wrapped around the conduit such that fluid leaving the one or more pressure containers passes through the conduit where heat is transferred to the fluid before it is dispensed from the spray system. In another embodiment, a heat exchanger is integrated between the conduit and the one or more pressure containers and/or integrated within the conduit itself. Fluid (water) passes through the heat exchanger, is heated to a higher temperature, and then continues through the conduit, hose, and is sprayed through the nozzle.

A further embodiment of the current disclosure provides for one or more storage compartments within the spray system. The storage compartments allow for one or more hoses to be stored with the spray system, along with other items. For example, a standard garden hose along with a trigger-style spray nozzle may be transported with the spray system by using the storage compartments. Such an embodiment enables a user to store and transport important components of the current system and method.

The system and method disclosed herein provides for connecting the sprayer system to a fluid source, as well as connecting a hose to one or more pressure containers. During transitional processes, such as connecting and disconnecting hoses to the inlet and outlet ports, the pressure within the pressure containers may cause fluid to escape. To reduce and/or eliminate fluid escaping during connection and disconnection of hoses to inlet and outlet ports, valves may be positioned within or in fluid connection with the inlet and/or outlet ports. For example, a user connects the hose to inlet port, and then opens the valve. Fluid flows through hose, through the inlet port and conduit, and then into the pressure container. The valve is then closed and the hose removed. To dispense fluid, a hose is connected to a dispensing outlet port, and the valve is opened. Fluid is then dispensed through the hose, as regulated by any nozzle attached at the opposing end, if any. After use, the valve is closed. In this fashion, fluid may be filled into and dispensed from the spray system with little spillage.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

That which is claimed:

1. A system comprising
a tank;
a pressure container, where the pressure container is encased within the tank; and
conduit, where the conduit comprises a coupler, where the conduit is in fluid connection with the pressure container, where the pressure container is airtight except for its fluid connection to the conduit.

2. The system of claim 1, wherein the conduit further comprises a second coupler.

3. The system of claim 1, further comprising a hose, where the hose is in fluid connection with the conduit.

4. The system of claim 4, wherein the hose comprises a spraying nozzle.

5. The system of claim 1, further comprising a second pressure container, where the pressure container is in fluid connection with the conduit.

6. The system of claim 1, wherein the pressure container is made from a rigid material.

7. The system of claim 1, wherein the tank is made from a rigid material.

8. The system of claim 1, wherein the conduit is made from a rigid material.

9. A method of dispensing a fluid comprising the steps of
connecting a spray system to a fluid source, where the spray system comprises a tank; a pressure container, where the pressure container is encased within the tank; and conduit, where the conduit comprises a coupler, where the conduit is in fluid connection with the pressure container, where the pressure container is airtight except for its fluid connection to the conduit;
filling the spray system with the fluid from the fluid source;
disconnecting the spray system from the fluid source;
transporting the spray system to a different location; and
dispensing the fluid from the spray system.

10. The method of claim 9, wherein the fluid is water.

11. The method of claim 9, wherein the fluid source is a residential water tap.

12. The method of claim 9, wherein the step of connecting a spray system to a fluid source comprises connecting one end of a hose to a residential water tap and the other end of the hose to the coupler of the conduit of the spray system.

13. The method of claim 9, wherein the step of dispensing the fluid from the spray system comprises connecting a hose to the coupler of the conduit of the spray system.

14. The method of claim 9, wherein the pressure container of the spray system is made from a rigid material.

15. The method of claim 9, wherein the spray system further comprises a second pressure container, where the second pressure container is in fluid connection with the conduit.

16. The method of claim 9, wherein the step of filling the spray system with the fluid from the fluid source comprises filling the pressure container of the spray system with the fluid until a pressure of sixty to one-hundred pounds per square inch within the pressure container is achieved.

17. The method of claim 9, wherein the conduit further comprises a second coupler.

18. A method of dispensing water comprising the steps of
connecting a portable shower system to a water source, where the portable shower system comprises a tank; a pressure container, where the pressure container is encased within the tank; and conduit, where the conduit comprises a coupler, where the conduit is in fluid connection with the pressure container, where the pressure container is airtight except for its fluid connection to the conduit;
filling the portable shower system with water from the water source, whereby water is stored within the pressure container;
disconnecting the portable shower system from the water source;
transporting the portable shower system to a different location;
connecting a hose to the coupler of the portable shower system, where the hose comprises a spray nozzle; and
discharging water held within the pressure container through the conduit, hose, and sprayer.

19. The method of claim 18, wherein the portable shower system further comprises a second pressure container, where the second pressure container is in fluid connection with the conduit.

20. The method of claim 18, wherein the portable shower system further comprises a second pressure container, where the second pressure container is in fluid connection with the conduit.
